(19) United States
(12) Patent Application Publication
(10) Pub. No.: US 2014/0372433 A1
(43) Pub. Date: Dec. 18, 2014

(54) Analysis of Event Driven Information

(71) Applicant: THE PATENT BOX, LLC, Springfield, PA (US)

(72) Inventor: Paul Dougherty, Springfield, PA (US)

(73) Assignee: THE PATENT BOX, LLC, Springfield, PA (US)

(21) Appl. No.: 14/301,620

(22) Filed: Jun. 11, 2014

Related U.S. Application Data
(60) Provisional application No. 61/834,416, filed on Jun. 12, 2013.

(51) Int. Cl. G06F 17/30

(52) U.S. Cl. CPC G06F 17/30011
USPC 707/736

(57) ABSTRACT

Event driven information may be analyzed. A plurality of electronic documents may be received. The plurality of electronic documents may represent activity in a plurality of cases. A respective plurality of event identifiers for each case may be generated based on the plurality of electronic documents. For example, each of the respective plurality of event identifiers may be a respective ordered list. And, a visual representation of the activity in the plurality of cases may be generated. The visual representation may be based on an aggregation of the respective plurality of event identifiers. The visualization may include a directional network of connected nodes. For example, each node may represent a respective event identifier and each respective plurality of event identifiers may represent a path in the network.

### CROSS-REFERENCE TO RELATED APPLICATIONS

This application claims the benefit of U.S. Provisional Application No. 61/834,416, filed Jun. 12, 2013, which is incorporated by reference in its entirety.

### BACKGROUND

Document analysis often involves identifying documents having one or more words, phrases or fact patterns of interest to a document researcher. Legal research is a type of document research that involves searching for such words, phrases or fact patterns of interest within documents associated with legal proceedings. A legal proceeding may have multiple phases, each phase involving one or more contended issues. For example, during patent prosecution, a legal proceeding that occurs between a patent practitioner or patent applicant and a patent office (e.g. the United States Patent and Trademark Office), a patent examiner may present one or more issues (e.g. written objections or rejections). In response to each contended issue a patent practitioner or applicant may take one of a variety of actions (e.g. a written rebuttal argument) to advance the legal proceeding. Determining the most appropriate action to take in response to a contended issue can be a time-consuming and complex task. Accordingly, legal practitioners often consult peers or perform legal research to identify documents or cases associated with other legal proceedings that demonstrate similar fact patterns. In this manner, the practitioner can obtain information to help them more efficiently determine an effective legal strategy.

However, discovering other cases with similar fact patterns and ultimately assessing the likelihood of success for a particular course of action is exceptionally difficult with current systems.

### SUMMARY

Event driven information may be analyzed. A plurality of electronic documents may be received. The plurality of electronic documents may represent activity in a plurality of cases. A respective plurality of event identifiers for each case may be generated based on the plurality of electronic documents. For example, each of the respective plurality of event identifiers may be a respective ordered list. And, a visual representation of the activity in the plurality of cases may be generated.

The visual representation may be based on an aggregation of the respective plurality of event identifiers. The visualization may include a directional network of connected nodes. For example, each node may represen a respective event identifier and each respective plurality of event identifiers may represent a path in the network.

### BRIEF DESCRIPTION OF THE DRAWINGS

FIG. 1 is a block diagram illustrating an example document research system

FIG. 2 is an example interface diagram.

FIG. 3 is an example interface diagram.

FIG. 4 is an example interface diagram.

FIG. 5 is an example interface diagram.

FIG. 6 is an example interface diagram.

FIG. 7 is a diagram illustrating an example process for analyzing electronic documents.

FIG. 8 is a diagram illustrating an example process for analyzing electronic documents.

### DETAILED DESCRIPTION

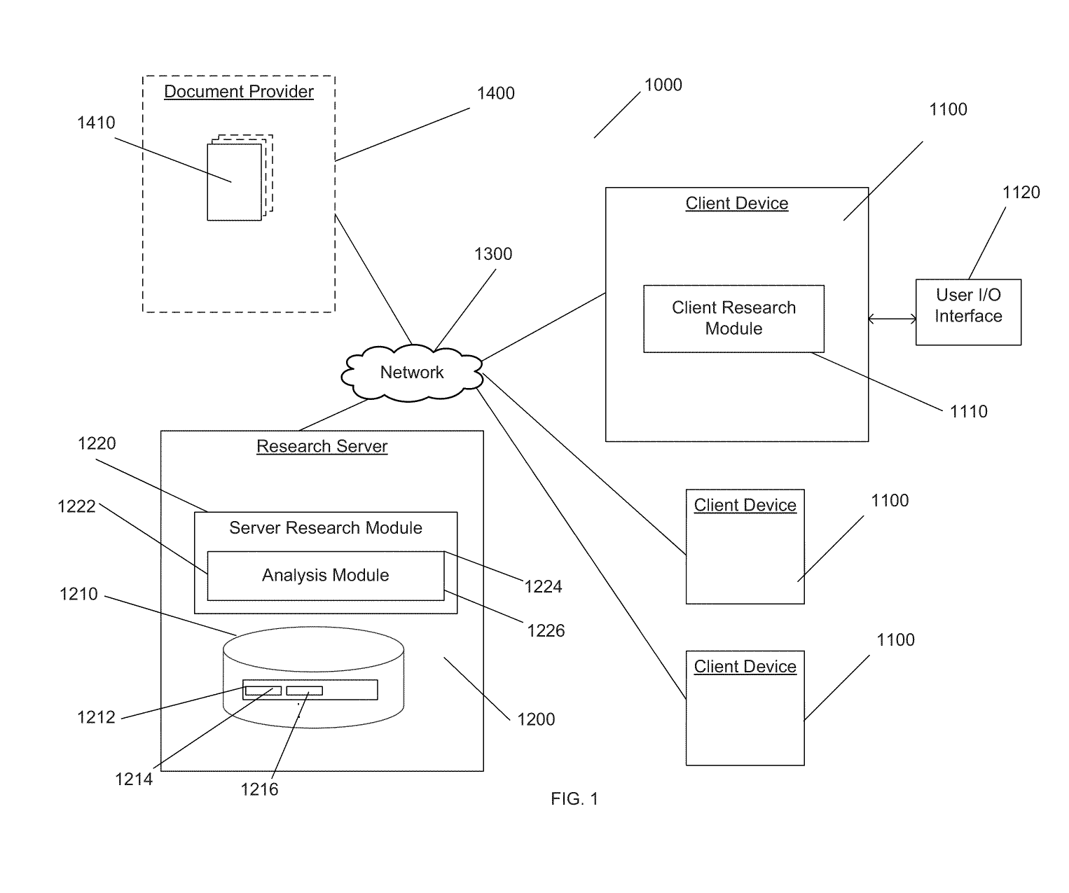

Referring to FIG. 1, a block diagram is shown illustrating an example document research system 1000. The document research system 1000 may include one or more client devices labeled generally as 1100, at least one research server 1200 and a network 1300. The client device 1100 may include a client research module 1110 and a user Input/Output (I/O) interface 1120. By way of example, the client device 1100 may be a computing device having a memory and a processor such as personal computer, a phone, a mobile phone, or a personal digital assistant. The I/O interface may include a display such as an LCD or CRT monitor configured to display a graphical user interface (GUI) for presenting a document research interface to the user. The research server 1200 may be a computing device having memory and a processor such as personal computer or may be implemented on a high performance server, such as a HP, IBM or Sun computer using an operating system such as, but not limited to, Linux, Solaris or UNIX. The research server 1200 may be a single computing device having a processor, memory and a relational or nosql database or may include multiple computers communicatively coupled in a distributed architecture. The memory of the client device 1100 and/or the memory of the research server 1200 may be non-transitory computer readable media (e.g., media intended for short term and/or long term data storage). The research server 1200 may include a server research module 1220 and a data repository 1210. The document research system 1000 may also comprise one or more document providers 1400. Each document provider 1400 is configured to deliver one or more electronic legal documents, labeled generally as 1410, to one of the client devices 1130 or to the research server 1200. By way of example, the electronic legal documents 1410 may be electronic files (e.g. .TIFF, .PDF or .txt files). Each file may contain a literal representation of an article such as legal proceeding document (e.g. a patent file history). Each document provider 1400 may be a remote server having a database of electronic documents (e.g. legal proceeding documents) such as the PAIR (Patent Application Information Retrieval) system provided by the United States Patent and Trademark Office (USPTO). The research server 1200, document provider 1400 and each of the client devices 1100 may be communicatively coupled to one another by way of network 1300. By way of example, network 1300 may be the Internet. The data repository 1210 of the research server 1200 may include a series of records 1212. Each record 1212 may include an electronic document file 1214 (or group of files) that is representative of a document (or group of documents) containing event-driven information about activity in certain cases. For example the document or documents may include a legal proceeding document (e.g. a patent file history) along with one or more corresponding metadata elements 1216. It is noted that while patent-related legal documents are the primary example focused on in describing the invention, the contemplated processes for researching event-driven documents may be applied to any type of event-driven document. Other event-driven documents may include various legal proceedings, fictional and non-fiction literature, as well as any form of plot or event-driven multi-media (including both video and audio). The analysis techniques described herein may be applied to non-documentary event driven activities, such as analyzing baseball statistics for example.

The electronic file 1214 may be a literal representation of the corresponding document or may be an alphanumeric string that can be used to identify the document (e.g. the electronic file 1214 may contain only the name or serial number of the document to which it corresponds). In this manner, the data repository 1210 may provide direct access to the document or may provide a user with an identifier which can be used to cross-reference the document in an external system (e.g. the USPTO PAIR database or the Google/Reed Bulk Data repositories). The electronic documents may alternately be stored in a remote server (e.g. Amazon S3 or a Rackspace Cloud server). A hyperlink to the remotely stored electronic document may be additionally stored in the record 1210.

The server research module 1220 may be a program module (or group of program modules) configured to provide access to the data repository 1210 and to handle communication between the research server 1200 and external devices including the client devices 1100 and the document provider 1400. A program module may generally include computer-readable instructions that when executed by a processor (such as the processor of research server 1200 for example) cause to the processor to perform certain actions. The server research module 1220 may access the data repository 1210 to add, update or delete records in the data repository or to retrieve data in response to a search query received from one of the client devices. The server research module 1220 may also comprise an analysis module 1222 for automatically generating metadata event tags/identifiers from processed document text. The analysis module 1222 may be a program module. The analysis module 1222 may be configured for automatically generating links (temporal or other) between the metadata event tags. The analysis module 1222 may be configured for facilitating the generation of graphical representations of search/analysis results.

The server research module 1220 may be configured to receive one or more electronic documents 1410 from the document provider 1400 by way of network 1300. By way of example, the network 1300 may be the Internet. The server research module 1220 may receive the electronic documents 1410 directly from the document provider 1400 or indirectly by way of one of the client devices 1100. The client research module 1110 may issue a request (e.g. an HTTP request) to the document provider 1400 for one or more of the electronic documents 1410. The document provider 1400 may respond by transmitting the one or more electronic documents 1410 to the client device 1100 that had issued the request. The client device 1100 may then transmit the received electronic documents 1410 to the research server 1200 (client-server messaging may be provided using HTTP requests or via a SOAP or RESTful web service). Upon receiving the electronic documents 1410, the server research module 1220 may then store each new or updated electronic document 1410 in one of the fields 1214 in the data repository 1210.

The client research module 1110 may be configured to receive the one or more electronic documents 1410 through the user I/O interface 1120. The documents 1410 may be stored on a portable storage device (not shown) such as a CD, DVD or solid state device and the user I/O interface 1120 may include a communications interface such as a wireless interface, a CD/DVD drive or a USB drive for retrieving data from the personal storage device. The electronic documents 1410 may alternately be generated from their corresponding paper-based documents and may be provided to the client research module 1110 by use of a scanner (not shown) that is configured with the I/O interface 1120.

The server research module 1220 may be configured to perform optical character recognition processing (using a program such as Tesseract provided by Google Inc.) on the electronic document 1410 when the electronic document is received as an image-based document such as a .TIFF or an image-based .PDF file. The server research module 1220 subsequently converts the electronic document to text which may then be indexed using a program such as Sphinx (provided by Sphinx Technologies Inc.). A corresponding text-only version of the document may be stored (e.g. as a .txt or .doc file) having a significantly smaller file size than the original image-based version of the document. The original image-based document may be optionally discarded or stored on a remote server (e.g. Amazon S3) resulting in significantly less storage space being needed to maintain the data repository 1210.

The server research module 1220 may further be configured to receive the previously discussed metadata elements 1216 from either the client devices 1100 or a remote server. Upon receiving attribute tags, the server research module 1220 may employ a program such as Sphinx provided by Sphinx Technologies Inc. to perform indexing of the text data. OCR or Speech-To-Text recognition processing may be optionally performed prior to upload to extract searchable text data from the metadata elements when they are in an image or audio-based format.

The server research module 1220 may be configured to access the data repository 1210 to retrieve records from the data repository in response to a search query received from one of the client devices 1100. By way of example, the search query may include one or more free-form alphanumeric key words or phrases. The search query may include one or more user-selected attribute tags. The server search module 1220 may perform a search of the records 1212 in the document repository 1210 to identify records 1212 that match the provided search criteria. Free-form alphanumeric search queries may be carried out on the electronic document fields 1214 and the metadata element fields 1216 that contain free-form text (i.e. comment fields). The attribute tag search queries may be carried out on the metadata element fields 1216 that conform to a structured taxonomy (i.e. attribute tags). Each type of search query may be carried out independently or in combination. When carried out in combination the search query defaults to a Boolean “AND” operation, thus the result set returned to the client device 1100 will be the intersection of the results of each search criteria included in the search request. It is to be understood that other logic operators may be employed.

The server research module may employ a program such as Sphinx provided by Sphinx Technologies Inc. to perform the search processing. The server search module 1220 may respond to the search query by transmitting the result set to the client device 1100 that issued the search query. By way of example the result set may include a list of document identifiers as well as hyperlinks that link directly to the electronic legal documents stored either on the research server or another remote server (e.g. document provider 1400 or Amazon S3). The result set may also include some or all of the metadata elements associated with each document.

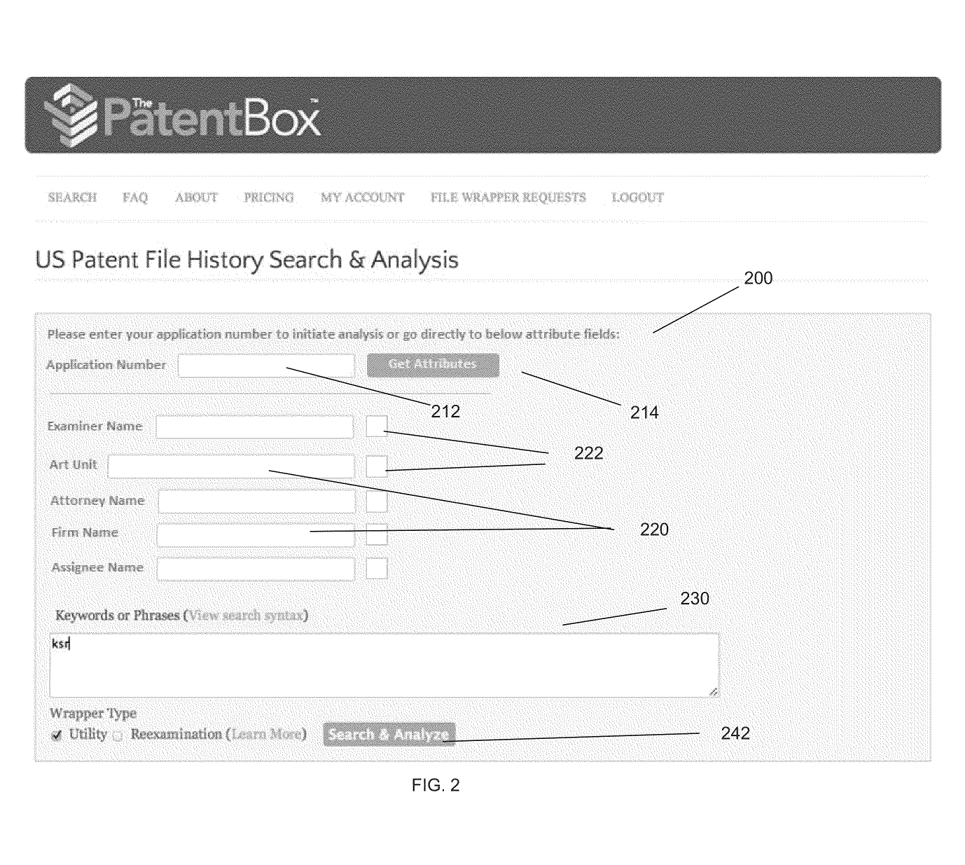

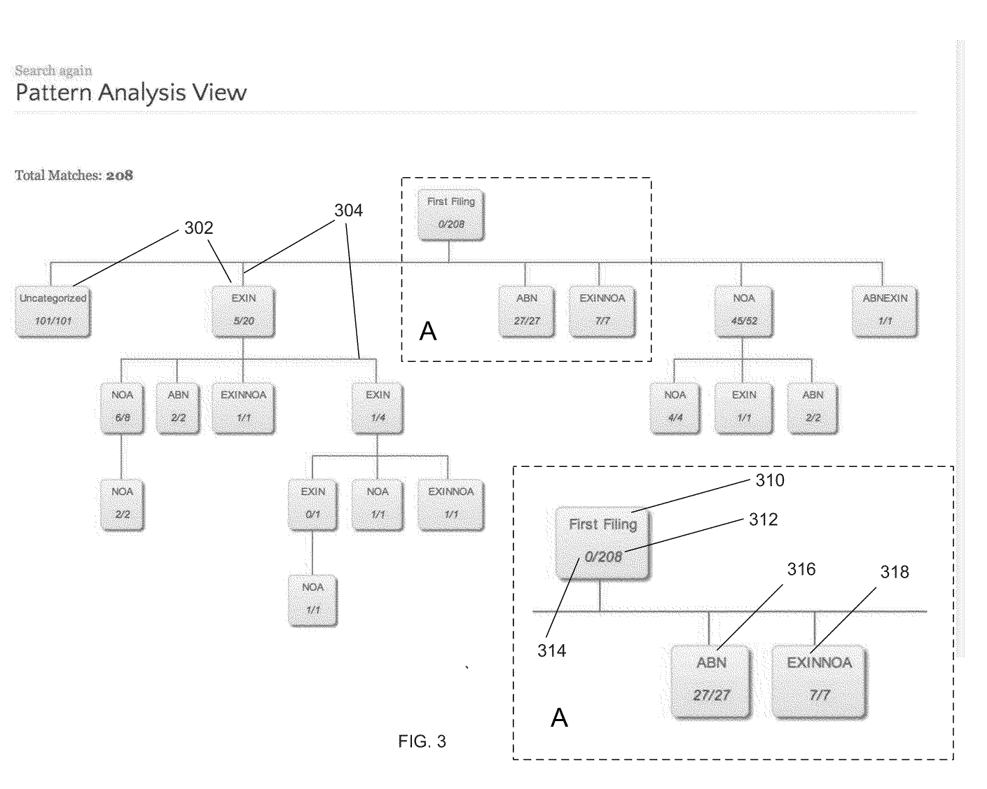

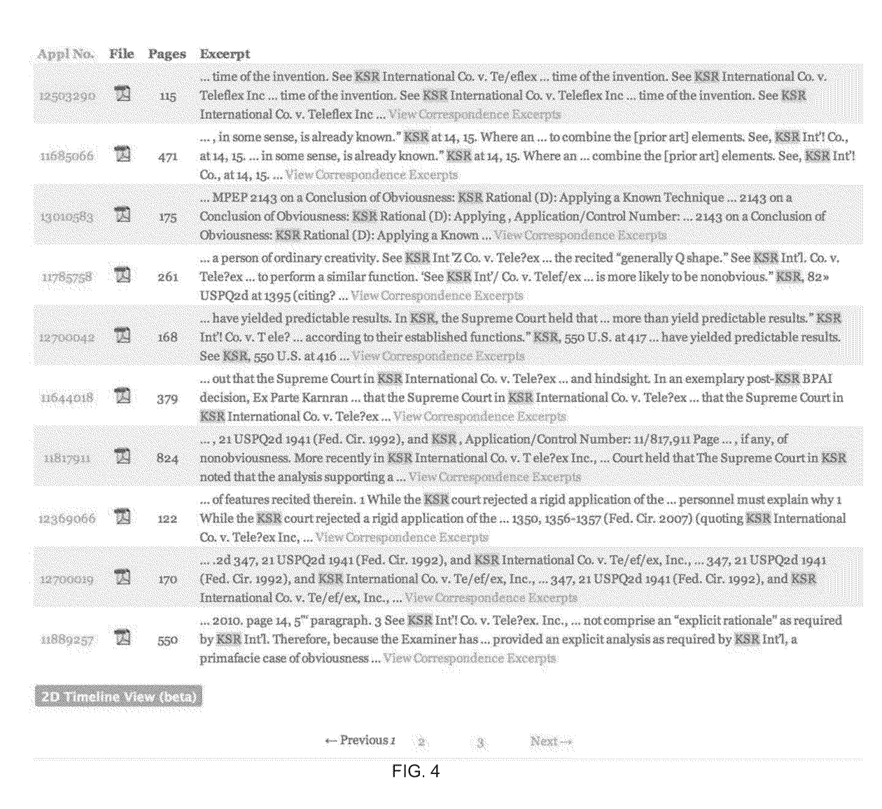

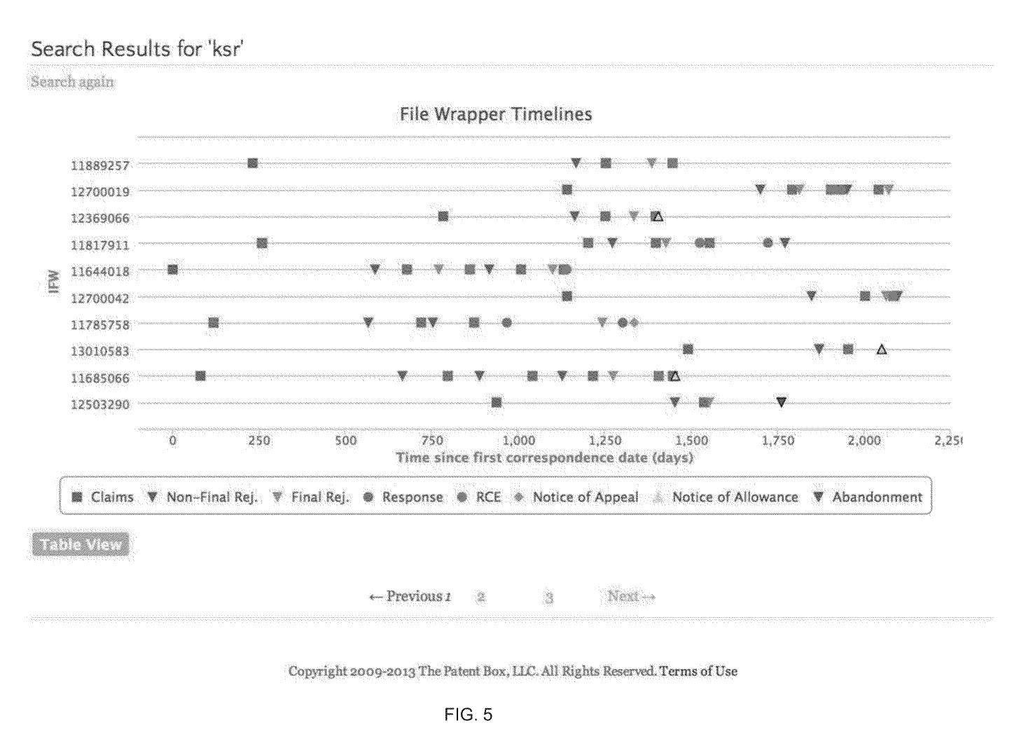

The client research module 1110 may be a program module configured to receive search queries by way of the I/O interface 1120 and/or to transmit the search queries to the research server 1200. The client research module 1110 may receive search query results and may display the results to the user by way of the I/O interface 1120. The search query results may be provided in the form of electronic documents, hyperlinks to electronic documents, or alphanumeric document identifiers. The search query results may also include metadata elements associated with each returned document. As shown in FIG. 4, the search results may be presented with text excerpts in a list form. The search query results may also be displayed graphically using time-tag information (shown in FIG. 5, for example). Aggregate attributes (e.g. merged event tags/identifiers) associated with the search query results may also be transmitted to the client research module. Such aggregate results may be displayed as a visualization such as a decision tree as shown in FIG. 3. The document research interface will now be discussed in greater detail with reference to FIG. 2.

Referring now to FIG. 2, diagrams are shown illustrating an example document research interface 200. As shown, the document research interface 200 may include a field 212 for entering an application number and a button 214 for extracting attributes from the associated application. Fields 220 and associated checkboxes 222 may be provided to allow the user to narrow search/analysis results to documents containing certain attributes (e.g. a specific patent attorney). The research interface 200 may include an alphanumeric key word or phrase section 230 that allows the users to limit the search results to documents (e.g. file wrappers) that have text that contain the entered words or phrases. Button 242 is provided for initiating the search/analysis process.

The document research interface 200 may be generated by the client interface module based on technology such as ASP.net, Ruby on Rails, JavaScript or a web framework such as Microsoft Silverlight. The data repository may be a relational database such as an Oracle or MySQL database. The client and server research modules may be implemented using ASP.NET, Ruby on Rails, Java or similar languages. The research server may be implemented using a web server technology such as Apache or Microsoft IIS.

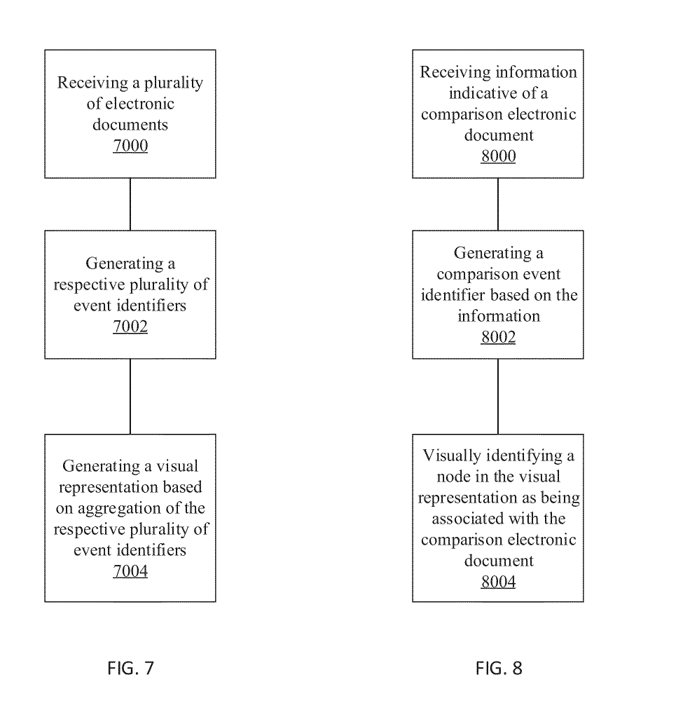

Referring now to FIG. 7, a plurality of electronic documents may be received at 7000. The plurality of electronic documents may represent activity in a plurality of cases. At 7002, a respective plurality of event identifiers may be generated. The respective plurality of event identifiers may be based on the plurality of electronic documents. For example, each of the respective plurality of event identifiers may be a respective ordered list. To illustrate, an example plurality of event identifiers may represent an ordered list of patent prosecution events in a particular patent application file history.

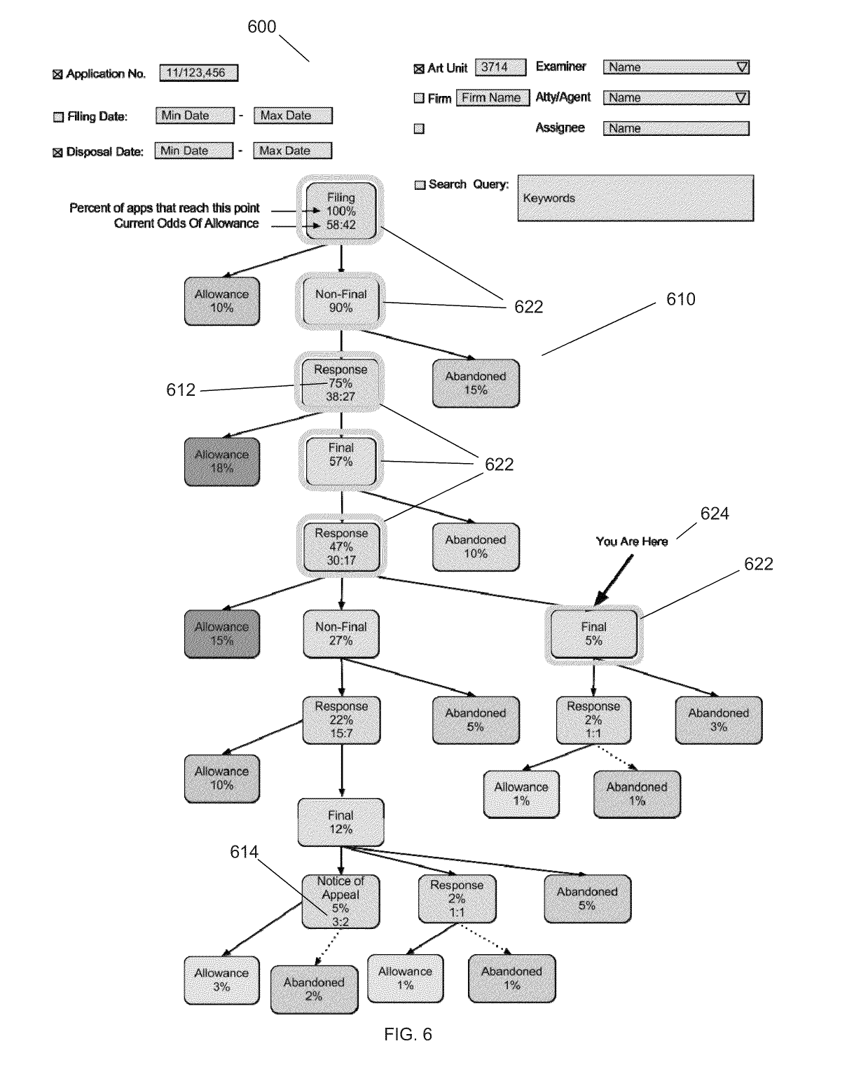

At 7004, a visual representation of the activity may be generated. The visual representation may be based on an aggregation of the respective plurality of event identifiers. For example, the aggregation may include determining a metric associated with one or more event identifiers. For example, the metric may include a relative percentage associated with an event identifier represented in the visualization. Where the visualization is a directional network of connected nodes, for example, the metric may be associated with a node and indicative of how many cases reach the node relative to the number of cases in the plurality of cases. For example, the metric may indicate how often a type of downstream event (e.g. a terminating event such as an Allowance) is reached, relative to a total number of downstream events. Here, for example, the total number of downstream events may be selected from a predetermined subset of events (e.g. terminating events such as Allowances and Abandonments). The metric may be represented as a ratio of downstream event types can be expressed (for example as depicted in FIG. 6).

The steps shown in FIG. 7 may be implemented by a server research module. In an example, a server research module may be adapted to receive a first set of electronic documents or document identifiers; generate a set of event identifiers for each of the received electronic documents; merge the sets of event identifiers; and generate a data structure suitable for displaying a visual representation of the merged sets of event identifiers. The visualization may be configured to illustrate aggregate event patterns that appear within the set of documents. For example, each document may represent one or more correspondences in a patent prosecution proceeding. It is noted that portions of the process carried out by the server research module may be carried out by the client research module or another remote server.

The server research module may be adapted to allow the set of electronic documents to be filtered based on the presence or absence of attributes associated with the documents. By way of example, the received attributes may be a word or phrase that appears in or is absent from the document text, one or more event identifiers, a date or range of dates of one or more event identifiers, and metadata associated with the document. The metadata elements may be user-generated or automatically-generated from document text by keyword or phrase matching or via the use of a text classifier algorithm such as those employed by the CRM 114 library and based on a predetermined taxonomy. The metadata elements may be pre-existing metadata elements extracted from a remote database (e.g. the USPTO Patent/Patent Application database) or a secondary storage device. Each metadata element may be an alphanumeric or boolean identifier that indicates the presence or absence of a characteristic. When employed for patent prosecution the metadata elements may include patent bibliographic data such as: technology classification, inventor name, application title, assignee name, examiner name, art unit, attorney name and law firm name. The event identifiers may represent a single event (e.g. a specific type of rejection, objection or applicant response on a certain date), a combination or sequence of events or a full fact pattern that appears within or is associated with the document represented by electronic file 1214. Event identifiers may include an event title, a corresponding event code and an event date.

As shown in FIG. 3, search/analysis results generated by the system may be a displayed as a visualization, such as a decision tree visualization for example. The visualization may include a directional network having nodes 302 and connections 304. Each node in the network may be associated with an event identifier. Each connection in the network may indicate a sequential relationship between nodes. For example, each node in the network may represent a respective event identifier. Each respective plurality of event identifiers may represent a path in the network of nodes. It is noted that the data structure used to generate such a decision tree visualization may be used to display other visualizations such as a treemap, a radial tree or the like.

The server research module may be configured to generate attributes for each node in the network. The node attributes may include information descriptive of the event or combination of events the node represents; information descriptive of the document or documents associated with the node; or aggregate characteristics of the node. Such aggregate characteristics may include: a percentage or number of documents which reach the node; a percentage or number of documents which terminate at the node; probability or odds that a downstream node is associated with a particular event identifier; percentage or number of documents that have a downstream node associated with a particular event; and the percentage of documents that have reached the node relative to the total number of documents that have reached any node with the same event identifier.

To illustrate, an example directional network may include a first node, a second node, and a third node. The first node may be connected to the second node. The first node may be connected to the third node. The first node may precede the second and third nodes. The second node may be associated with a metric, such as a percentage, for example. The percentage may be based on the number of paths that include the first node and the number of paths that include first and second nodes. Thus, the percentage may be indicative of how often activity similarly situated to the event represented by the first node ultimately proceeded to the second node (for example, as opposed to proceeding from the first node to the third node). The second node may be associated with a metric that is indicative of how many cases reach the node relative to the number of cases in the plurality of cases. For example, the metric may indicate how often a type of node is reached, relative to a total number of relevant nodes. Here, for example, the relevant nodes may be selected from a predetermined subset of nodes. The metric may be represented as a ratio of downstream event types (for example as depicted in FIG. 6).

As shown in the blown-up portion A of FIG. 3, each node may be shown visually as a box 310. Node information may be shown within or near the box using text or other visual means (e.g. color, shape etc). The nodes 310 of FIG. 3, for example, illustrate one method of displaying event identifiers textually. Element 316 represents an event identifier labeled “ABN” which is a patent prosecution correspondence code that corresponds to an Abandonment event. Element 318 shows an event identifier labeled “EXINNOA” which is a combination of patent prosecution events: the “EXIN” code corresponds to an Examiner Interview and the “NOA” code corresponds to a Notice of Allowance. Prosecution events may be combined to form a single event identifier when they occur on the same date (and optionally time/time window) and optionally when they originate from the same source (e.g. either the USPTO or the applicant/attorney). Elements 312 and 314 represent aggregate characteristics of the node. Element 312 shows the number of documents in the result set (resulting from a general search of the term “KSR”) which have a prosecution history that reaches the node. Element 314 shows the number of documents in the result set which have a prosecution history that terminates at the node.

FIG. 6 illustrates an alternate search and analysis results interface which shows the use of different aggregate characteristics including: percentage of documents which reach the node (see element 612 which illustrate 75% of documents reach the “Filing→Non-Final Rejection→Response” event sequence); and odds that a downstream node is associated with a particular event identifier (see element 614 which illustrates that responding with a “Notice of Appeal” provides 3:2 odds of ultimately receiving an Allowance).

For example, a processor may receive first information indicative of a patent application. And, the processor may transmit second information indicative of a visual representation of the past patent prosecution of the patent application and potential future patent prosecution of the patent application. The potential future patent prosecution may comprises percentages based on an analysis patent prosecution documents in other patent applications.

The research modules may be adapted to calculate one or more numeric attributes for the nodes 302 that can be used to generate a visual representation of the node attributes. By way of example, the visual attributes may include one or more of color, size and shape however it is noted that other visual features may be employed to illustrate node attributes (e.g. various animations may be employed such as blinking). To utilize color as a node attribute, the research module may be configured to generate one or more numeric color property values (e.g. hue, tint, shade, tone, saturation, lightness, chroma, intensity, brightness, grayscale) in relation (e.g. proportional, or binned) to one or more of the aggregate metrics associated with the node. The research modules may be configured to generate one or more numeric size values in relation (e.g. proportional) to one or more of the aggregate characteristics of the node. The research modules may be configured to select a shape for the nodes where the selected shape is associated with a predetermined range of values of one of the aggregate characteristics of the node. It is noted that other non-numeric node attributes may be used to determine visual characteristics of a node. For example, nodes that have event identifiers corresponding to prosecution events that originate with the USPTO may have one shape or color (e.g. square or red) while nodes that have event identifiers corresponding to prosecution events that originate with the Applicant or Attorney may have a different shape or color (e.g. round or blue).

The research module may be configured to receive a comparison document and/or comparison document identifier. This may be used to assist a user in quickly formulating an analysis search relevant to their interests and subsequently provide a visualization that illustrates aspects of the comparison document in the context of another set of related documents. FIG. 8 illustrates an example process that employs the use of a comparison document.

For example, at 8000, information indicative of a comparison electronic document may be received. For example, the comparison electronic document may represent a file history for a patent application. At 8002, a comparison event identifier may be generated. The comparison event identifier may be based on the received information. At 8004, a node in the visual representation may be visually identified as being associated with the comparison electronic document. In an example, this node may be visually identified with a text label, for example reciting, “You are here.” To illustrate, the node 622, shown in FIG. 6, is visually identified as being associated with a comparison document. The process shown in FIG. 8 may be performed independently of or in connection with the process shown in FIG. 7.

A user interface 200 may be provided by the research system as shown in FIG. 2 for initiating and running an analysis search. The interface 200 may include field 212 for receiving a patent application number from a user and a “Get Attributes” button 214. Upon receiving the application number and click event, the server research module may retrieve attributes associated with the entered application from a document repository. The attributes may include information such as Examiner Name(s), Art Unit, Attorney Name, Firm Name and Assignee Name. The research server module may analyze the comparison document and suggest keywords or phrases by calculating word and/or phrase frequency from the document text and selecting the most frequently occurring words or phrases (e.g. top 5). The research server module may transmit this information back to the client which will then auto-populate fields 220 and optionally 230 with this information.

The user may check one or more of the checkboxes 222 associated with each field to indicate the particular field that should be used to formulate the search analysis query. The user may enter keywords or phrases to limit the scope of the search and analysis results. The user may bypass the attribute extraction process and directly enter information (e.g. Examiner Name, Art Unit, Attorney Name, Firm Name or Assignee) into any or all of fields 222. The user may click the “Search & Analyze” button 242 to instruct the research modules to generate a search analysis report.

As shown in the FIG. 6, a decision tree 610 shows an aggregation of the event paths that occur within the documents that appear in the result set. The research module generates a set of event identifiers from the comparison document which is retrieved based on the comparison document identifier. The research module generates one or more additional visual elements for highlighting the event sequence of the comparison document within the larger set of result documents. One or more of the nodes that the comparison document may traverse in its event sequence may be visually differentiated in the decision tree visualization. Each node that the comparison document has traversed may have a yellow highlighting place around it (see each of the nodes labeled 622). A separate visual indicator (e.g. a “You Are Here” text label) may be provided to highlight the sequentially latest node the comparison document has reached. In this manner a patent attorney or agent can quickly determine how the comparison case is proceeding relative to other similar cases. And, this may allow them to react to a typical fact pattern, and it may provide them with a mechanism to determine a path forward that has historically shown a high likelihood of success.

FIG. 6 shows that various search filters may be included on the search and analysis report result page to allow the scope of the document results to be broadened or narrowed to meet their needs. FIG. 6 illustrates that certain event types (e.g. disposal events including Allowances and Abandonments) may have unique statistics with additional visualization properties. Allowance nodes may all be shown in a certain color (e.g. Green) with varying degrees of brightness to provide a big-picture illustration of which paths provide the highest or lowest likelihoods of reaching an allowance. It is noted that while color and brightness are used in the current embodiment to illustrate allowance likelihood, a variety of visual indicators (e.g. size) may be used.

The research server module may generate event identifiers for each document based on a master set of predetermined event identifiers (e.g. PAIR codes). The event identifiers may represent activity in one or more cases (e.g. patent applications). The event identifiers may be generated from a selected set of event identifiers selected from the master set of event identifiers. By way of example, the selected set may be user-selected or admin-selected for the purpose of helping the end users analyze a certain event type (e.g. effectiveness of Examiner Interview) or to simplify/de-clutter the visual analysis results. Each event may be comprised of an event name and an event date. The event may include a document code. The documents of the exemplary system may be PDF documents containing dated bookmarks. The set of event identifiers is generated and ordered by processing the date and text information that appears within each bookmark. The text information for each bookmark may be compared to a master set of event names to event code mappings to extract the appropriate event code. Event identifiers are generated for each group of prosecution event codes that appear on a unique date. For each event identifier the codes are first ordered (alphabetically) and concatenated. Event identifiers may be ordered by date to represent the event sequence for the document. It is noted that the event codes may be divided and/or subdivided based on origin (patent office vs. applicant), finer time granularity or other attributes. It is noted that other methods may be employed for generating event identifiers. Document text may be analyzed to identify specific events within each correspondence (or chapter in a book application).

The research sever module may carry out a process in which a data structure is developed that can be used to generate a decision tree visualization.

By way of example, the following code segment is provided to illustrate how ordered sets of event identifiers (ordered by date) may be generated and how they may be merged into a data structure that can drive a decision tree visualization such as that shown in FIG. 3. The below code may be configured to generate aggregate node characteristics including the number of documents which reach each node and the number of documents which terminate at the node.

----------------------------------------------------------------------
--Start Code Segment
#This retrieves all document results based on the search query
@results = Document.search(@term, {

| | |
|---|---|
| :with | => {:wrapper_type => wrapper_types}, |

:match_mode =>

```
params[:mode].to_sym}.merge(sort_options))
#create the data_table for the visualization
data_table = TreeTable.DataTable.new
data_table.new_column(‘string’, ‘Event’ )
data_table.new_column(‘string’, ‘Parent Event’)
data_table.new_column(‘string’, ‘ToolTip’)
prev_code = ‘First Filing’;
all_codes = {“FF” => 1}
i=1;
#create matrix data structure that will drive the decision tree
visualization
#also handle creation of “first filing” and “uncategorized” events
rows = [ ]
rows << [{v: “-FF-”, f: ‘First Filing’}, ‘’, ‘First Filing’,0,0]
rows << [{v: “-FFUNK-”, f: ‘Uncategorized’}, ‘-FF-’, ‘First
Filing/Uncat’,0,0]
#allowed_codes = [‘EXIN’, ‘CTNF’, ‘CTFR’, ‘NOA’, ‘ABN’]
#Note that any PAIR document codes may be included here - can be user
supplied
allowed_codes = [‘EXIN’, ‘NOA’, ‘ABN’]
#build the event sequences for each document and merge the result into
the decision tree data structure
@results.each do |doc|
  @corrs = doc.correspondences
  dates = @corrs.map {|x| x.issue_date}
  event_dates = dates.uniq
  #build array of event id's - assumes 1 event per date
  @event_ids = [‘FF’]
  event_dates.sort.each do |current_date|
  corrs_on_date = @corrs.find_all { |corr| corr.issue_date ==
current_date}
  #create the event id
  event_id = [ ]
  corrs_on_date.each do |current_corr|
```

if allowed_codes.include?(current_corr.document_code)
event_id << current_corr.document_code
end

```
  end
  unless event_id.empty?
```

#uniq - consolidate duplicate corr codes that appear on the same

day

#sort - ensure corrs appearing in different order within the day

won't matter

@event_ids << event_id.uniq.sort

```
  end
end
  #get index of first filing event in
  ff_idx = rows.index{|node, parent, tooltip, count,t_count| node[:v]
== ‘-FF-’}
  node_id = ‘’
  prev_code = ‘-FF-’
#create the rows for the chart
  @event_ids.each do |event|
```

```
    p_node_id = node_id;
    event_id = ‘-’ + [event].join + ‘-’; #dashes are important -
```

(e.g. ABS-ABSCLM is different than ABSABS-CLM)

#create a node id - note the node id captuures the full event

sequence

```
    node_id = node_id + event_id;
    #determine if a node with the same id already exists
    idx = rows.index{|node, parent, tooltip, count| node[:v] ==
```

node_id}

#handle existing event - increment the has_reached and

termination counts

if idx != nil

```
rows[idx][3] = rows[idx][3] +1;
rows[idx][4] = rows[idx][4] +1;
unless rows[idx][1] == ‘’
  #get parent index
  idx2 = rows.index{|node, parent, tooltip, count| node[:v]
```

== rows[idx][1]}

```
  #decrement termination count of parent
  rows[idx2][4] = rows[idx2] [4] − 1;
end
```

```
    #handle new event
    else
```

rows << [{v: node_id, f: event_id.gsub(“-

”,“ ”)},prev_code,event_id,1,1]

p_idx = rows.index{|node, parent, tooltip, count| node[:v] ==

p_node_id}

unless p_idx == nil
#the next line has the effect of decrementing the First

Filing Node termination count

rows[p_idx][4] = rows[p_idx][4] − 1;
end
STDOUT << [{v: node_id, f: event_id.gsub(“-

”,“ ”)},prev_code,event_id,1.to_s]

STDOUT << “\n”

```
    end
    prev_code = node_id;
```

```
  end
  #handle uncategorized docs
  #anytime document has no event_ids in the allowed list, we consider
it an uncategorized document
  if @event_ids.length == 1
    idx = rows.index{|node, parent, tooltip, count,t_count| node[:v] ==
‘-FFUNK-’}
    rows[idx][3] = rows[idx][3] +1;
    rows[idx][4] = rows[idx][4] +1;
    #this handles decrementing the first filing
    rows[ff_idx][4] = rows[ff_idx][4] −1;
  end
end
#transform the tree data structure to a format required for the
visualization library
#this also handles formatting the node text and visual properties foe
each node
chart_rows = [ ]
rows.each do |node, parent, tooltip, count,t_count|
  if count >0
    chart_rows << [{v: node[:v], f: “#{node[:f]}<div style=‘color:red;
font-style:italic’>#{t_count}/#{count}</div>”},parent,tooltip]
  end
end
data_table.add_rows(chart_rows)
opts = { :allowHtml => true , :allowCollapse => true}
@chart = DecisionTree.new(data_table, opts)
--End Code Segment
----------------------------------------------------------------------
```

Aggregate node attributes may be generated by traversing the full tree or nodes downstream in a current branch depending on the desired metric. By way of example, probability or odds that a downstream node is associated with a particular event identifier may be computed by traversing each of the downstream nodes and summing the document counts for each node (or terminal node) that exhibits the event identifier of interest (e.g. Abandoned or Notice of Allowance). This number may be divided by the total documents that have reached the current node and shown as either a percentage or ratio.

The above techniques and program modules may be implemented as electronic hardware, computer software, or combinations of both. The various illustrative program modules and steps have been described generally in terms of their functionality. Whether the functionality is implemented as hardware or software depends in part upon the hardware constraints imposed on the system. Hardware and software may be interchangeable depending on such constraints. As examples, the various illustrative program modules and steps described in connection with the embodiments disclosed herein may be implemented or performed with an application specific integrated circuit (ASIC), a field programmable gate array (FPGA) or other programmable logic device, discrete gate or transistor logic, discrete hardware components, a conventional programmable software module and a processor, or any combination thereof designed to perform the functions described herein. The processor may be a microprocessor, CPU, controller, microcontroller, programmable logic device, array of logic elements, or state machine. The software modules may reside in RAM memory, flash memory, ROM memory, EPROM memory, EEPROM memory, hard disk, a removable disk, a CD, DVD or any other form of storage medium known in the art. An example processor may be coupled to the storage medium so as to read information from, and write information to, the storage medium. In the alternative, the storage medium may be integral to the processor.

Those skilled in the art will appreciate that the foregoing methods can be implemented by the execution of a program embodied on a non-transitory computer readable medium. The medium may comprise, for example, RAM accessible by, or residing within the device. Whether contained in RAM, a diskette, or other secondary storage media, the program modules may be stored on a variety of machine-readable data storage media, such as a conventional “hard drive”, magnetic tape, electronic read-only memory (e.g., ROM or EEPROM), flash memory, an optical storage device (e.g., CD, DVD, digital optical tape), or other suitable data storage media.

1. A method comprising:
receiving a plurality of electronic documents, the plurality of electronic documents representing activity in a plurality of cases;
generating a respective plurality of event identifiers for each case based on the plurality of electronic documents; and
generating a visual representation of the activity in the plurality of cases, wherein the visual representation is based on aggregation of the respective plurality of event identifiers.

2. The method of claim 1, wherein each of the respective plurality of event identifiers is a respective ordered list.

3. The method of claim 1, wherein the visualization is a directional network of connected nodes, each node representing a respective event identifier, wherein each respective plurality of event identifiers represents a path in the network.

4. The method of claim 3, wherein the aggregation comprises determining a metric associated with a node and indicative of how many cases reach the node relative to the number of cases in the plurality of cases.

5. The method of claim 4, wherein the directional network comprises a first node, a second node, and a third node, wherein the first node is connected to the second node, and the first node is connected to the third node, wherein the first node precedes the second and third nodes, and wherein second node is associated with a percentage based on a number of paths that include first node and a number of paths that include first and second nodes.

6. The method of claim 1, further comprising filtering the plurality of electronic documents based on the presence or absence of attributes associated with the documents, wherein the attributes may comprise one or more of: a word or phrase that appears in or is absent from the document text, one or more event identifiers, a date or date ranges of one or more event identifiers, and metadata associated with the document.

7. The method of claim 1, wherein the plurality of electronic documents comprises patent prosecution documents.

8. The method of claim 7, wherein the aggregation of the respective plurality of event identifiers comprises determining one or more of: a percentage or number of documents which reach a node; a percentage or number of documents which terminate at a node; probability or odds that a downstream node is associated with a particular event identifier or combination of event identifiers, and percentage or number of documents that have a downstream node associated with a particular event identifier or combination of event identifiers.

9. The method claim 1, further comprising:
receiving information indicative of a comparison electronic document;
generating a comparison event identifier based on the information; and
visually identifying a node in the visual representation as being associated with the comparison electronic document.

10. The method of claim 9, wherein the visually identifying comprises a text indication that recites, “You are here.”

11. A device comprising:
a processor; and
a memory comprising computer-readable instructions that when executed by the processor, cause the processor to:
receive a plurality of electronic documents, the plurality of electronic documents representing activity in a plurality of cases;
generate a respective plurality of event identifiers for each case based on the plurality of electronic documents; and
generate a visual representation of the activity in the plurality of cases, wherein the visual representation is based on aggregation of the respective plurality of event identifiers.

12. The device of claim 11, wherein each of the respective plurality of event identifiers is a respective ordered list.

13. The device of claim 11, wherein the visualization is a directional network of connected nodes, each node representing a respective event identifier, wherein each respective plurality of event identifiers represents a path in the network.

14. The device of claim 13, wherein the aggregation comprises determining a metric associated with a node and indicative of how many cases reach the node relative to the number of cases in the plurality of cases.

15. The device of claim 14, wherein the directional network comprises a first node, a second node, and a third node, wherein the first node is connected to the second node, and the first node is connected to the third node, wherein the first node precedes the second and third nodes, and wherein second node is associated with a percentage based on number of paths that include first node and the number of paths that include first and second nodes.

16. The device of claim 11, wherein the memory further comprises computer-readable instructions that when executed by the processor, cause the processor to filter the plurality of electronic documents based on the presence or absence of attributes associated with the documents, wherein the attributes may comprise one or more of: a word or phrase that appears in or is absent from the document text, one or more event identifiers, a date or date ranges of one or more event identifiers, and metadata associated with the document.

17. The device of claim 1, wherein the plurality of electronic documents comprises patent prosecution documents.

18. The device of claim 17, wherein the aggregation of the respective plurality of event identifiers comprises determining one or more of: a percentage or number of documents which reach a node; a percentage or number of documents which terminate at a node; probability or odds that a downstream node is associated with a particular event identifier or combination of event identifiers, and percentage or number of documents that have a downstream node associated with a particular event identifier or combination of event identifiers.

19. The device of claim 11, wherein the memory further comprises computer-readable instructions that when executed by the processor, cause the processor to:
receive information indicative of a comparison electronic document;
generate a comparison event identifier based on the information; and
visually identify a node in the visual representation as being associated with the comparison electronic document.

20. A method comprising:
receiving, at a processor, first information indicative of a patent application;
transmitting, by the processor, second information indicative of a visual representation of the past patent prosecution of the patent application and potential future patent prosecution of the patent application, wherein the potential future patent prosecution comprises percentages based on an analysis patent prosecution documents in other patent applications.
